(19) United States
(12) Patent Application Publication
(10) Pub. No.: US 2026/0303532 A1
(43) Pub. Date: Oct. 1, 2026

(54) PROVIDING FAST TUNNEL REROUTE FOR NETWORK CONVERGENCE

(71) Applicant: Juniper Networks, Inc., Sunnyvale, CA (US)

(72) Inventors: Vivek Sheel BANGER, Bangalore (IN); Deepak KAKRANIA, Bangalore (IN); Suraj KUMAR, Bangalore (IN)

(21) Appl. No.: 19/093,869

(22) Filed: Mar. 28, 2025

(51) Int. Cl. H04L 47/125; H04L 45/00

(52) U.S. Cl. CPC H04L 47/125; H04L 45/14

(57) ABSTRACT

An edge network device may define a plurality of tunnels through a plurality of network devices, and may load balance traffic flows among the plurality of tunnels. The edge network device may detect a failure associated with a network device of the plurality of network devices, and may identify a tunnel, of the plurality of tunnels, that is associated with the network device. The edge network device may remove the tunnel from an equal-cost multi-path configuration to prevent the traffic flows over the tunnel, and may redistribute the traffic flows among the plurality of tunnels other than the tunnel.

### BACKGROUND

Ethernet virtual private network (EVPN) tunnel is a network technology that enables the extension of Layer 2 Ethernet services over a Layer 3 Internet protocol (IP) or a multiprotocol label switching (MPLS) network. An EVPN tunnel provides a scalable and flexible solution for data center interconnects, enterprise networks, and service provider networks by using a border gateway protocol (BGP) to distribute media access control (MAC) address reachability information.

### SUMMARY

Some implementations described herein relate to a method. The method may include defining a plurality of tunnels through a plurality of network devices, and load balancing traffic flows among the plurality of tunnels. The method may include detecting a failure associated with a network device of the plurality of network devices, and identifying a tunnel, of the plurality of tunnels, that is associated with the network device. The method may include removing the tunnel from an equal-cost multi-path configuration to prevent the traffic flows over the tunnel.

Some implementations described herein relate to an edge network device. The edge network device may include one or more memories and one or more processors. The one or more processors may be configured to define a plurality of tunnels through a plurality of network devices, and load balance traffic flows among the plurality of tunnels. The one or more processors may be configured to detect a failure associated with a network device of the plurality of network devices, and identify a tunnel, of the plurality of tunnels, that is associated with the network device. The one or more processors may be configured to remove the tunnel from an equal-cost multi-path configuration to prevent the traffic flows over the tunnel, and redistribute the traffic flows among the plurality of tunnels other than the tunnel.

Some implementations described herein relate to a non-transitory computer-readable medium that stores a set of instructions. The set of instructions, when executed by one or more processors of an edge network device, may cause the edge network device to define a plurality of tunnels through a plurality of network devices, wherein each of the plurality of tunnels is an Ethernet virtual private network type 5 tunnel. The set of instructions, when executed by one or more processors of an edge network device, may cause the edge network device to load balance traffic flows among the plurality of tunnels, and detect a failure associated with a network device of the plurality of network devices. The set of instructions, when executed by one or more processors of an edge network device, may cause the edge network device to identify a tunnel, of the plurality of tunnels, that is associated with the network device, and remove the tunnel from an equal-cost multi-path configuration to prevent the traffic flows over the tunnel.

### BRIEF DESCRIPTION OF THE DRAWINGS

FIGS. 1A-1D are diagrams of an example associated with providing fast tunnel reroute for network convergence.

FIG. 2 is a diagram of an example environment in which systems and/or methods described herein may be implemented.

FIGS. 3 and 4 are diagrams of example components of one or more devices of FIG. 2.

FIG. 5 is a flowchart of an example process for providing fast tunnel reroute for network convergence.

### DETAILED DESCRIPTION

The following detailed description of example implementations refers to the accompanying drawings. The same reference numbers in different drawings may identify the same or similar elements.

An EVPN tunnel may fail due to connection failures and/or device failures associated with one or more network devices. EVPN enables redundant and efficient distribution of traffic flows over multiple paths in a network by using equal-cost multi-path (ECMP) type tunnels (e.g., type 2 tunnels, type 5 tunnels, and/or the like) for traffic forwarding. Bidirectional forwarding detection (BFD) may be utilized to monitor the health of tunnels, for quick detection of tunnel failures. However, in conventional systems, a BFD identified tunnel failure may result in a high network convergence time (e.g., on the order of seconds) to reallocate traffic flows from the failed tunnel to operational tunnels. The high network convergence time is due to a make-before-break (MBB) operation performed by a control plane of a network device managing the failed tunnel. In the MBB operation, the control plane may create a new ECMP configuration by removing the failed tunnel from an existing ECMP configuration. The control plane may also reallocate all type 5 prefix routes from the existing ECMP configuration to the new ECMP configuration. Performance of the MBB operation may take several seconds and may result in excessive traffic loss in EVPN networks. The network convergence time may vary based on a scale of routes associated with the failed tunnels.

Thus, current techniques for handling tunnel failures consume computing resources (e.g., processing resources, memory resources, communication resources, and/or the like), networking resources, and/or the like that are associated with failing to provide a fast network convergence when a tunnel fails, handling excessive traffic loss due to failing to provide fast network convergence when a tunnel fails, handling customer complaints associated with the excessive traffic loss, and/or the like.

Some implementations described herein relate to an edge network device that provides fast tunnel reroute for network convergence. For example, the edge network device may define a plurality of tunnels through a plurality of network devices, and may load balance traffic flows among the plurality of tunnels. The edge network device may detect a failure associated with a network device of the plurality of network devices, and may identify a tunnel, of the plurality of tunnels, that is associated with the network device. The edge network device may remove the tunnel from an equal-cost multi-path configuration to prevent the traffic flows over the tunnel, and may redistribute the traffic flows among the plurality of tunnels other than the tunnel.

In this way, the edge network device may provide fast tunnel reroute for network convergence. For example, the edge network device may associate or map tunnels with corresponding BFD sessions, and may monitor the BFD sessions for tunnel failures. When a tunnel fails, the edge network device may be notified of a BFD session failure. Upon detecting the failure of the BFD session, the edge network device may identify a specific tunnel associated with the BFD session failure. The edge network device (e.g., a packet forwarding component of the edge network device) may remove the failed tunnel from an existing ECMP configuration, which may prevent traffic from provided over a non-operational path associated with the failed tunnel. The edge network device may instantly redistribute traffic across remaining active tunnels of the ECMP configuration. After removal of the failed tunnel, a control plane of the edge network device may perform an MBB operation that verifies network routing adjustments without interrupting traffic.

Thus, the edge network device conserves computing resources, networking resources, and/or the like that would otherwise have been consumed by failing to provide a fast network convergence when a tunnel fails, handling excessive traffic loss due to failing to provide fast network convergence when a tunnel fails, handling customer complaints associated with the excessive traffic loss, and/or the like.

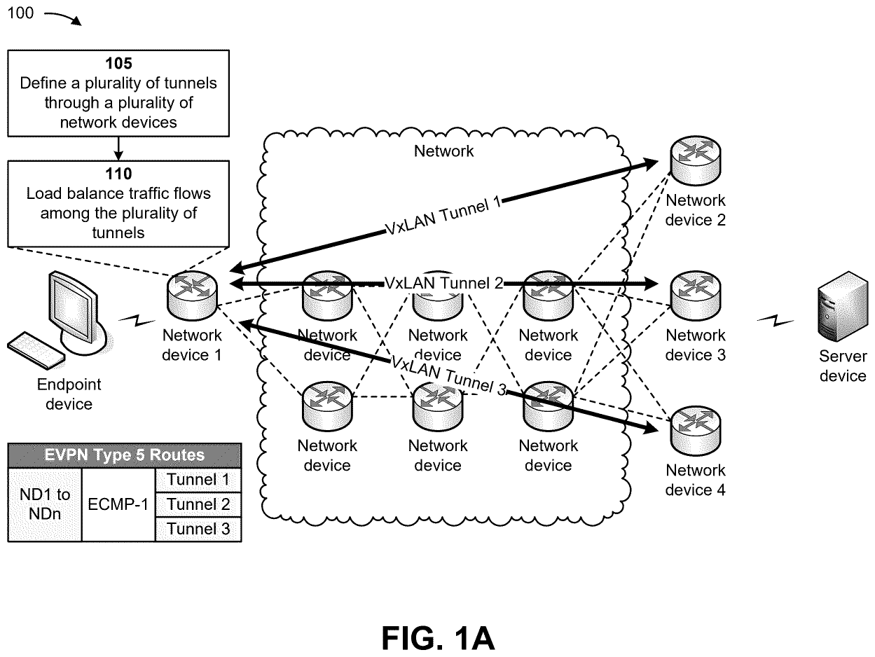

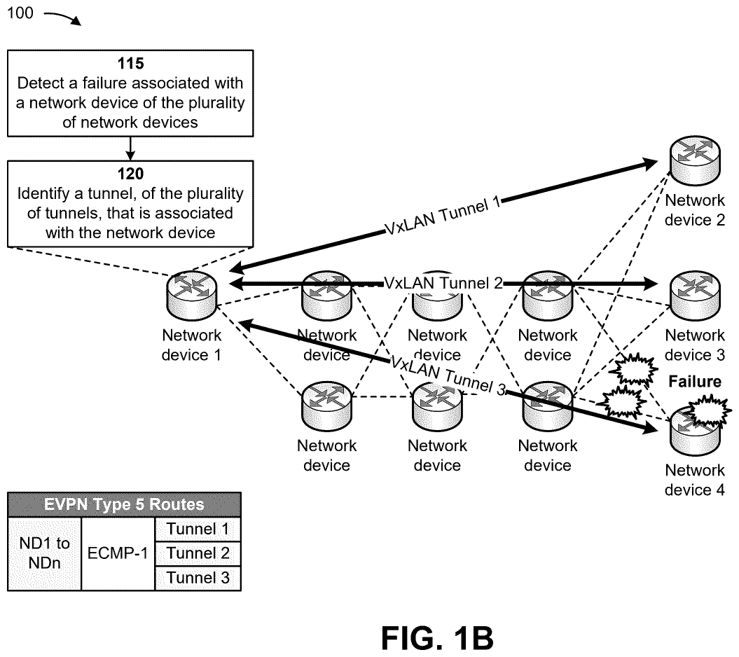

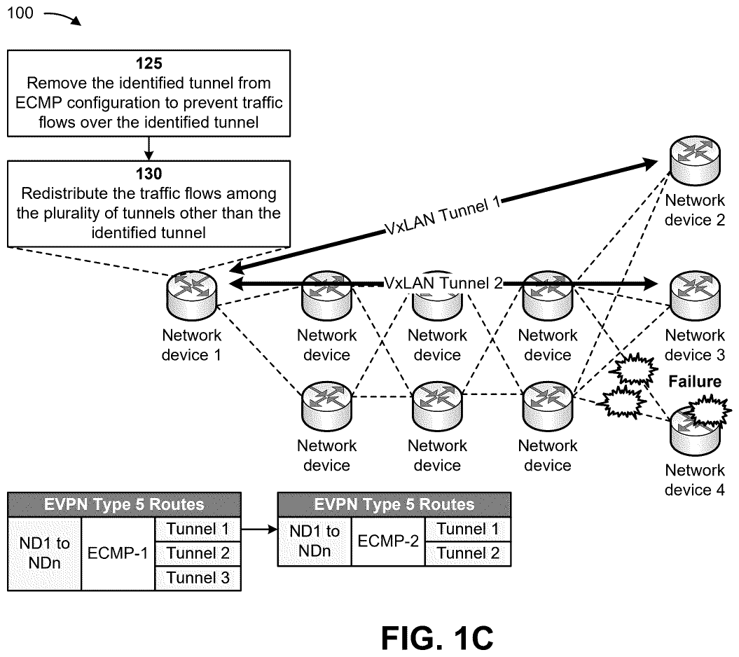

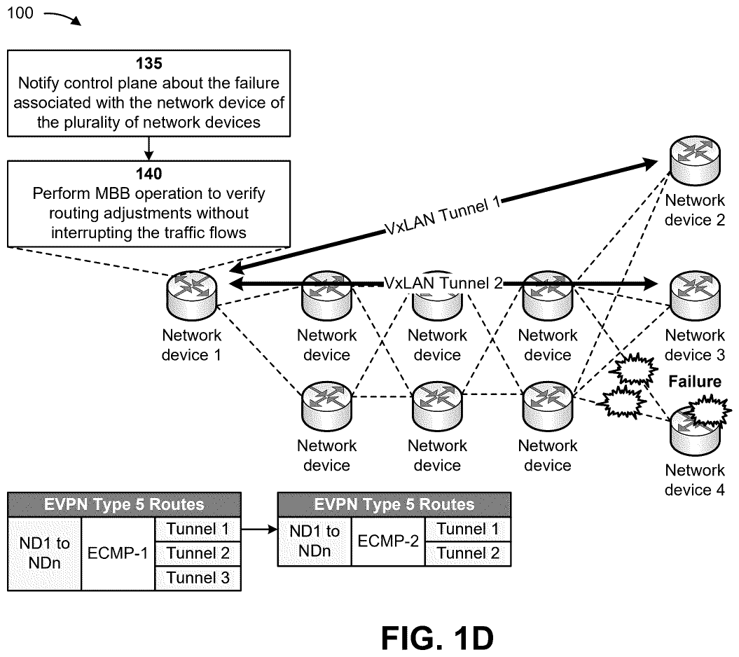

FIGS. 1A-1D are diagrams of an example 100 associated with providing fast tunnel reroute for network convergence. As shown in FIGS. 1A-1D, the example 100 includes an endpoint device associated with a network and a server device. The network may include multiple network devices, such as provider edge network devices (e.g., network device 1, network device 2, network device 3, and network device 4) and multiple intermediate network devices. Further details of the endpoint device, the network, the server device, and the network devices are provided elsewhere herein. In some implementations, there may be more than one endpoint device and/or more than server device.

As shown in FIG. 1A, and by reference number 105, a provider edge network device (e.g., network device 1) may define a plurality of tunnels through a plurality of network devices. For example, to create a tunnel (e.g., virtual extensible local area network (VxLAN) tunnel 1) between network device 1 and network device 2, an underlay BGP may be configured on interface addresses between network device 1 and network device 2. At network device 1, an overlay multiprotocol-BGP (MP-BGP) may be configured for an address associated with network device 2. At network device 2, an overlay MP-BGP may be configured for an address associated with network device 1. At network device 1, a multi-hop BFD may be configured for the address associated with network device 2. At network device 2, a multi-hop BFD may be configured for the address associated with network device 1. The VxLAN tunnel 1 may be provided from network device 1, through one or more network devices of the network, and may terminate at network device 2.

To create a tunnel (e.g., VxLAN tunnel 2) between network device 1 and network device 3, an underlay BGP may be configured on interface addresses between network device 1 and network device 3. At network device 1, an overlay MP-BGP may be configured for an address associated with network device 3. At network device 3, an overlay MP-BGP may be configured for an address associated with network device 1. At network device 1, a multi-hop BFD may be configured for the address associated with network device 3. At network device 3, a multi-hop BFD may be configured for the address associated with network device 1. The VxLAN tunnel 2 may be provided from network device 1, through one or more network devices of the network, and may terminate at network device 3.

To create a tunnel (e.g., VxLAN tunnel 3) between network device 1 and network device 4, an underlay BGP may be configured on interface addresses between network device 1 and network device 4. At network device 1, an overlay MP-BGP may be configured for an address associated with network device 4. At network device 4, an overlay MP-BGP may be configured for an address associated with network device 1. At network device 1, a multi-hop BFD may be configured for the address associated with network device 4. At network device 4, a multi-hop BFD may be configured for the address associated with network device 1. The VxLAN tunnel 3 may be provided from network device 1, through one or more network devices of the network, and may terminate at network device 4.

In some implementations, network device 2, network device 3, and network device 4 may advertise corresponding “n” EVPN type-5 route prefixes to network device 1, via MP-BGP. Network device 1 may create a routing table (e.g., ECMP-1) of a tunnel next hop (e.g., Next hop[tunnel1, tunnel2, tunnel3]) based on receiving the “n” EVPN type-5 route prefixes from network device 2, network device 3, and network device 4. Network device 1 may install the “n” EVPN type-5 route prefixes pointing to the ECMP-1.

As further shown in FIG. 1A, and by reference number 110, the provider edge network device may load balance traffic flows among the plurality of tunnels. For example, network device 1 may receive (e.g., from the endpoint device) traffic flows to be provided through the network and to the server device. In some implementations, network device 1 may receive a quantity (e.g., “M”) of traffic flows from the endpoint device, and the traffic flows may include Layer 3 (L3) traffic flows. The L3 traffic flows may include network traffic that is managed at a network layer that is responsible for logical addressing (Internet protocol (IP) addressing), routing, and packet forwarding. The L3 traffic flows may include IP packets associated with end-to-end delivery of data across different networks. In some implementations, network device 1 may load balance the “M” traffic flows among the plurality of tunnels (e.g., VxLAN tunnel 1, VxLAN tunnel 2, and VxLAN tunnel 3). For example, network device 1 may equally load balance the “M” traffic flows so that each tunnel receives an equivalent traffic load (e.g., M/3 of the traffic flows may be provided to each of the three tunnels).

As shown in FIG. 1B, and by reference number 115, the provider edge network device may detect a failure associated with a network device of the plurality of network devices. For example, network device 1 may configure a first multi-hop BFD for the address associated with network device 2, may configure a second multi-hop BFD for the address associated with network device 3, and may configure a third multi-hop BFD for the address associated with network device 4. Network device 2 may configure the first multi-hop BFD for the address associated with network 1, network device 3 may configure the second multi-hop BFD for the address associated with network 1, and network device 4 may configure the third multi-hop BFD for the address associated with network 1. As further shown in FIG. 1B, network device 4 may experience a failure due to becoming inoperable or to losing connectivity with the network. When network device 4 experiences the failure, a hardware-assisted BFD of network device 1 may receive an indication of the failure associated with network device 4. The hardware-assisted BFD of network device 1 may inform packet forwarding component (e.g., with a hardware-assisted BGP) of network device 1 about the failure associated with network device 4. Based on the failure, the packet forwarding component of network device 1 may withdraw all advertised routes associated with network device 4 from a forwarding path of network device 1.

As further shown in FIG. 1B, and by reference number 120, the provider edge network device may identify a tunnel, of the plurality of tunnels, that is associated with the network device. For example, the packet forwarding component of network device 1 may utilize the address associated with the failed network device (e.g., network device 4) and the routing table (e.g., ECMP-1) to identify the tunnel associated with the failed network device. Based on the routing table, the packet forwarding component of network device 1 may identify VxLAN tunnel 3 as being associated with network device 4 (e.g., the failed network device).

As shown in FIG. 1C, and by reference number 125, the provider edge network device may remove the identified tunnel from an ECMP configuration to prevent the traffic flows over the identified tunnel. For example, the packet forwarding component of network device 1 may remove the identified tunnel (e.g., VxLAN tunnel 3) from the ECMP configuration (e.g., the ECMP-1 routing table) to generate a new ECMP configuration (e.g., a new routing table ECMP-2). By removing the identified tunnel from the ECMP configuration, the packet forwarding component of network device 1 may prevent traffic flows over the identified tunnel and may result in a traffic convergence of less than one second.

As further shown in FIG. 1C, and by reference number 130, the provider edge network device may redistribute the traffic flows among the plurality of tunnels other than the identified tunnel. For example, network device 1 may continue to receive (e.g., from the endpoint device) traffic flows to be provided through the network and to the server device. In some implementations, network device 1 may continue to receive the quantity (e.g., “M”) of traffic flows from the endpoint device, and the traffic flows may include L3 traffic flows. In some implementations, the packet forwarding component of network device 1 may redistribute the “M” traffic flows among the plurality of tunnels (e.g., VxLAN tunnel 1 and VxLAN tunnel 2) other than the identified tunnel (e.g., VxLAN tunnel 3). For example, the packet forwarding component of network device 1 may equally load balance the “M” traffic flows so that each tunnel receives an equivalent traffic load (e.g., M/2 of the traffic flows may be provided to each of the two remaining tunnels). Thus, the traffic flows may be instantly (e.g., in less than one second) redistributed across the remaining active tunnels in the ECMP configuration.

As shown in FIG. 1D, and by reference number 135, the provider edge network device may notify a control plane of the provider edge network device about the failure associated with the network device of the plurality of network devices. For example, the packet forwarding component of network device 1 may notify the control plane of network device 1 about the failure associated with the network device (e.g., network device 4) of the plurality of network devices. In some implementations, The hardware-assisted BGP of the packet forwarding component of network device 1 may notify the control plane of network device 1 about the failure associated with network device 4.

As further shown in FIG. 1D, and by reference number 140, the provider edge network device may perform an MBB operation to verify routing adjustments without interrupting the traffic flows. For example, the control plane of network device 1 may utilize the address associated with the failed network device (e.g., network device 4) and the routing table (e.g., ECMP-1) to identify the tunnel associated with the failed network device. Based on the routing table, the control of network device 1 may identify VxLAN tunnel 3 as being associated with network device 4 (e.g., the failed network device). After identifying the tunnel associated with the failed network device, the control plane of network device 1 may perform the MBB operation to verify network routing adjustments without interrupting traffic. In the MBB operation, the control plane of network device 1 may move each route from the original ECMP configuration (e.g., ECMP-1 with tunnels 1, 2, and 3) to the new ECMP configuration (e.g., ECMP-2 with tunnels 1 and 2) without affecting traffic convergence of the traffic flows. Implementations described herein may improve network convergence by 94% to almost 99% compared to current techniques for handling tunnel failures.

In this way, the edge network device may provide fast tunnel reroute for network convergence. For example, the edge network device may associate or map tunnels with corresponding BFD sessions, and may monitor the BFD sessions for tunnel failures. When a tunnel fails, the edge network device may be notified of a BFD session failure. Upon detecting the failure of the BFD session, the edge network device may identify a specific tunnel associated with the BFD session failure. The edge network device (e.g., a packet forwarding component of the edge network device) may remove the failed tunnel from an existing ECMP configuration, which may prevent traffic from provided over a non-operational path associated with the failed tunnel. The edge network device may instantly redistribute traffic across remaining active tunnels of the ECMP configuration. After removal of the failed tunnel, a control plane of the edge network device may perform an MBB operation that verifies network routing adjustments without interrupting traffic.

Thus, the edge network device conserves computing resources, networking resources, and/or the like that would otherwise have been consumed by failing to provide a fast network convergence when a tunnel fails, handling excessive traffic loss due to failing to provide fast network convergence when a tunnel fails, handling customer complaints associated with the excessive traffic loss, and/or the like.

As indicated above, FIGS. 1A-1D are provided as an example. Other examples may differ from what is described with regard to FIGS. 1A-1D. The number and arrangement of devices shown in FIGS. 1A-1D are provided as an example. In practice, there may be additional devices, fewer devices, different devices, or differently arranged devices than those shown in FIGS. 1A-1D. Furthermore, two or more devices shown in FIGS. 1A-1D may be implemented within a single device, or a single device shown in FIGS. 1A-1D may be implemented as multiple, distributed devices. Additionally, or alternatively, a set of devices (e.g., one or more devices) shown in FIGS. 1A-1D may perform one or more functions described as being performed by another set of devices shown in FIGS. 1A-1D.

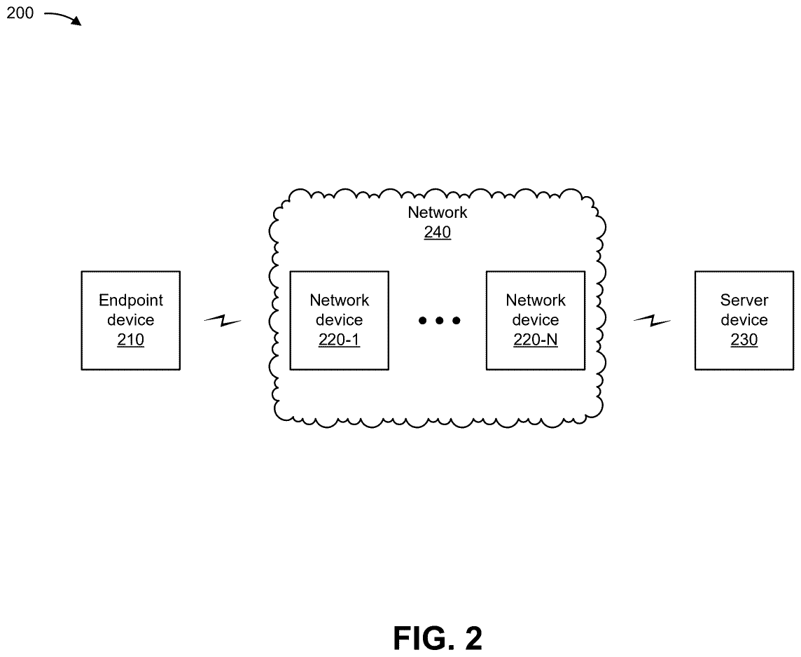

FIG. 2 is a diagram of an example environment 200 in which systems and/or methods described herein may be implemented. As shown in FIG. 2, environment 200 may include an endpoint device 210, a group of network devices 220 (shown as network device 220-1 through network device 220-N), a server device 230, and a network 240. Devices of the environment 200 may interconnect via wired connections, wireless connections, or a combination of wired and wireless connections.

The endpoint device 210 includes one or more devices capable of receiving, generating, storing, processing, and/or providing information, such as information described herein. For example, the endpoint device 210 may include a mobile phone (e.g., a smart phone or a radiotelephone), a laptop computer, a tablet computer, a desktop computer, a handheld computer, a gaming device, a wearable communication device (e.g., a smart watch, a pair of smart glasses, a heart rate monitor, a fitness tracker, smart clothing, smart jewelry, or a head mounted display), a network device, a server device, a group of server devices, or a similar type of device. In some implementations, the endpoint device 210 may receive network traffic from and/or may provide network traffic to other endpoint devices 210 and/or the server device 230, via the network 240 (e.g., by routing packets using the network devices 220 as intermediaries).

The network device 220 includes one or more devices capable of receiving, processing, storing, routing, and/or providing traffic (e.g., a packet or other information or metadata) in a manner described herein. For example, the network device 220 may include a router, such as a label switching router (LSR), a label edge router (LER), an ingress router, an egress router, a provider router (e.g., a provider edge router or a provider core router), a virtual router, a route reflector, an area border router, or another type of router. Additionally, or alternatively, the network device 220 may include a gateway, a switch, a firewall, a hub, a bridge, a reverse proxy, a server (e.g., a proxy server, a cloud server, or a data center server), a load balancer, and/or a similar device. In some implementations, the network device 220 may be a physical device implemented within a housing, such as a chassis. In some implementations, the network device 220 may be a virtual device implemented by one or more computer devices of a cloud computing environment or a data center. In some implementations, a group of network devices 220 may be a group of data center nodes that are used to route traffic flow through the network 240.

The server device 230 may include one or more devices capable of receiving, generating, storing, processing, providing, and/or routing information, as described elsewhere herein. The server device 230 may include a communication device and/or a computing device. For example, the server device 230 may include a server, such as an application server, a client server, a web server, a database server, a host server, a proxy server, a virtual server (e.g., executing on computing hardware), or a server in a cloud computing system. In some implementations, the server device 230 may include computing hardware used in a cloud computing environment.

The network 240 includes one or more wired and/or wireless networks. For example, the network 240 may include a packet switched network, a cellular network (e.g., a fifth generation (5G) network, a fourth generation (4G) network, such as a long-term evolution (LTE) network, and a third generation (3G) network), a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

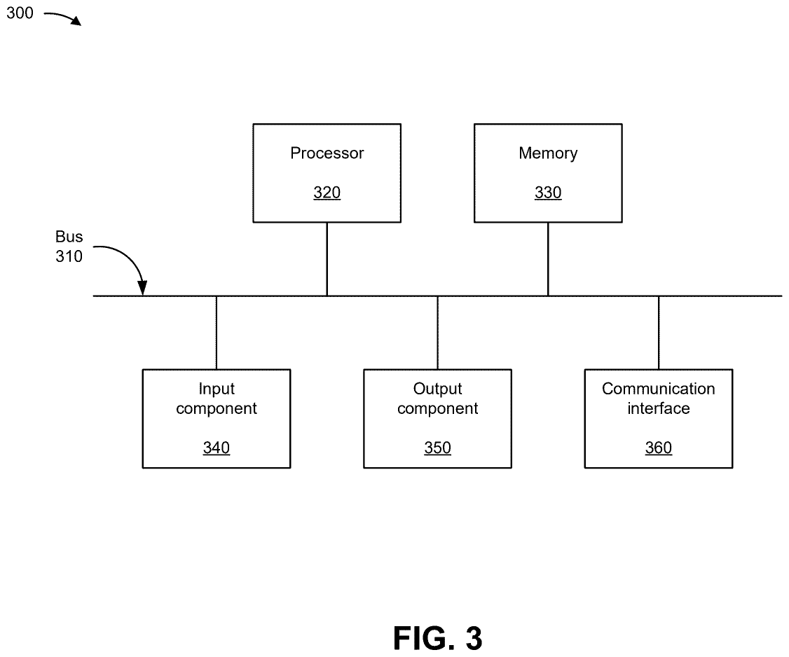

FIG. 3 is a diagram of example components of one or more devices of FIG. 2. The example components may be included in a device 300, which may correspond to the endpoint device 210, the network device 220, and/or the server device 230. In some implementations, the endpoint device 210, the network device 220, and/or the server device 230 may include one or more devices 300 and/or one or more components of the device 300. As shown in FIG. 3, the device 300 may include a bus 310, a processor 320, a memory 330, an input component 340, an output component 350, and a communication interface 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit (CPU), a graphics processing unit (GPU), an application processing unit (APU), a microprocessor, a controller, a microcontroller, a digital signal processor (DSP), a field-programmable gate array (FPGA), an application-specific integrated circuit (ASIC), and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication interface 360 enables the device 300 to communicate with other devices via a wired connection and/or a wireless connection. For example, the communication interface 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

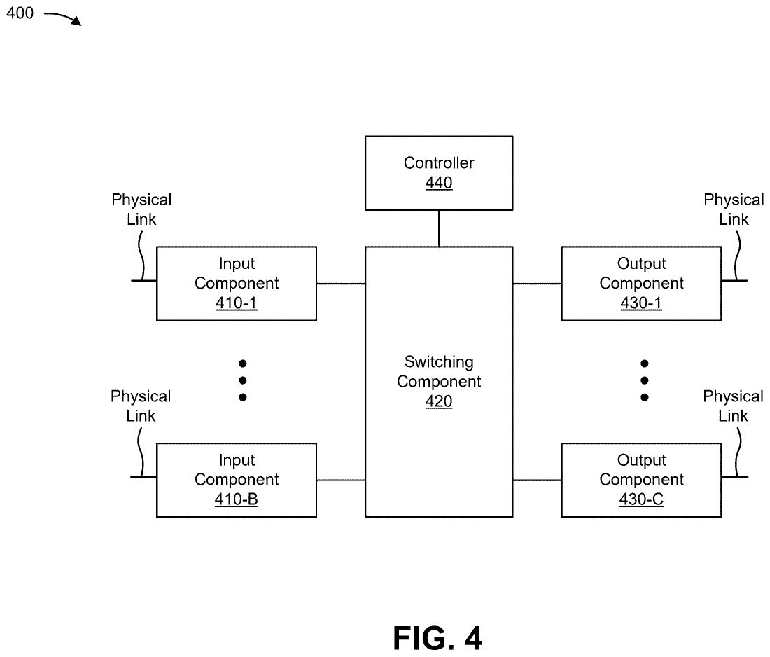

FIG. 4 is a diagram of example components of one or more devices of FIG. 2. The example components may be included in a device 400. The device 400 may correspond to the network device 220. In some implementations, the network device 220 may include one or more devices 400 and/or one or more components of the device 400. As shown in FIG. 4, the device 400 may include one or more input components 410-1 through 410-B (B≥1) (hereinafter referred to collectively as input components 410, and individually as input component 410), a switching component 420, one or more output components 430-1 through 430-C (C≥1) (hereinafter referred to collectively as output components 430, and individually as output component 430), and a controller 440.

The input component 410 may be one or more points of attachment for physical links and may be one or more points of entry for incoming traffic, such as packets. The input component 410 may process incoming traffic, such as by performing data link layer encapsulation or decapsulation. In some implementations, the input component 410 may transmit and/or receive packets. In some implementations, the input component 410 may include an input line card that includes one or more packet processing components (e.g., in the form of integrated circuits), such as one or more interface cards (IFCs), packet forwarding components, line card controller components, input ports, processors, memories, and/or input queues. In some implementations, the device 400 may include one or more input components 410.

The switching component 420 may interconnect the input components 410 with the output components 430. In some implementations, the switching component 420 may be implemented via one or more crossbars, via busses, and/or with shared memories. The shared memories may act as temporary buffers to store packets from the input components 410 before the packets are eventually scheduled for delivery to the output components 430. In some implementations, the switching component 420 may enable the input components 410, the output components 430, and/or the controller 440 to communicate with one another.

The output component 430 may store packets and may schedule packets for transmission on output physical links. The output component 430 may support data link layer encapsulation or decapsulation, and/or a variety of higher-level protocols. In some implementations, the output component 430 may transmit packets and/or receive packets. In some implementations, the output component 430 may include an output line card that includes one or more packet processing components (e.g., in the form of integrated circuits), such as one or more IFCs, packet forwarding components, line card controller components, output ports, processors, memories, and/or output queues. In some implementations, the device 400 may include one or more output components 430. In some implementations, the input component 410 and the output component 430 may be implemented by the same set of components (e.g., and input/output component may be a combination of the input component 410 and the output component 430).

The controller 440 includes a processor in the form of, for example, a CPU, a GPU, an APU, a microprocessor, a microcontroller, a DSP, an FPGA, an ASIC, and/or another type of processor. The processor is implemented in hardware, firmware, or a combination of hardware and software. In some implementations, the controller 440 may include one or more processors that can be programmed to perform a function.

In some implementations, the controller 440 may include a RAM, a ROM, and/or another type of dynamic or static storage device (e.g., a flash memory, a magnetic memory, an optical memory, etc.) that stores information and/or instructions for use by the controller 440.

In some implementations, the controller 440 may communicate with other devices, networks, and/or systems connected to the device 400 to exchange information regarding network topology. The controller 440 may create routing tables based on the network topology information, may create forwarding tables based on the routing tables, and may forward the forwarding tables to the input components 410 and/or output components 430. The input components 410 and/or the output components 430 may use the forwarding tables to perform route lookups for incoming and/or outgoing packets.

The controller 440 may perform one or more processes described herein. The controller 440 may perform these processes in response to executing software instructions stored by a non-transitory computer-readable medium. A computer-readable medium is defined herein as a non-transitory memory device. A memory device includes memory space within a single physical storage device or memory space spread across multiple physical storage devices.

Software instructions may be read into a memory and/or storage component associated with the controller 440 from another computer-readable medium or from another device via a communication interface. When executed, software instructions stored in a memory and/or storage component associated with the controller 440 may cause the controller 440 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, the device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

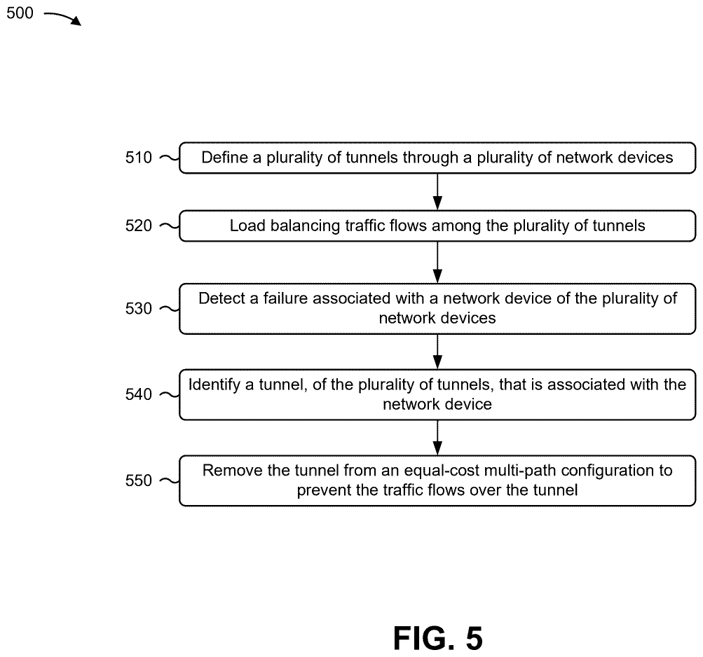

FIG. 5 is a flowchart of an example process 500 for providing fast tunnel reroute for network convergence. In some implementations, one or more process blocks of FIG. 5 may be performed by a network device (e.g., a network device 220). In some implementations, one or more process blocks of FIG. 5 may be performed by another device or a group of devices separate from or including the network device, such as another network device (e.g., a network device 220). Additionally, or alternatively, one or more process blocks of FIG. 5 may be performed by one or more components of the device 300, such as the processor 320, the memory 330, the input component 340, the output component 350, and/or the communication interface 360. Additionally, or alternatively, one or more process blocks of FIG. 5 may be performed by one or more components of the device 400, such as the input component 410, the switching component 420, the output component 430, and/or the controller 440.

As shown in FIG. 5, process 500 may include defining a plurality of tunnels through a plurality of network devices (block 510). For example, the edge network device may define a plurality of tunnels through a plurality of network devices, as described above. In some implementations, each of the plurality of tunnels is an Ethernet virtual private network type 5 tunnel. In some implementations, the plurality of network devices form an Ethernet virtual private network.

As further shown in FIG. 5, process 500 may include loading balancing traffic flows among the plurality of tunnels (block 520). For example, the edge network device may load balancing traffic flows among the plurality of tunnels, as described above.

As further shown in FIG. 5, process 500 may include detecting a failure associated with a network device of the plurality of network devices (block 530). For example, the edge network device may detect a failure associated with a network device of the plurality of network devices, as described above.

As further shown in FIG. 5, process 500 may include identifying a tunnel, of the plurality of tunnels, that is associated with the network device (block 540). For example, the edge network device may identify a tunnel, of the plurality of tunnels, that is associated with the network device, as described above. In some implementations, identifying the tunnel, of the plurality of tunnels, that is associated with the network device includes utilizing a packet forwarding component of the edge network device to identify the tunnel, of the plurality of tunnels, that is associated with the network device.

As further shown in FIG. 5, process 500 may include removing the tunnel from an equal-cost multi-path configuration to prevent the traffic flows over the tunnel (block 550). For example, the edge network device may remove the tunnel from an equal-cost multi-path configuration to prevent the traffic flows over the tunnel, as described above. In some implementations, removing the tunnel from the equal-cost multi-path configuration includes utilizing a packet forwarding component of the edge network device to remove the tunnel from the equal-cost multi-path configuration.

In some implementations, process 500 includes redistributing the traffic flows among the plurality of tunnels other than the tunnel. In some implementations, process 500 includes notifying a control plane of the edge network device about the failure associated with the network device, to cause the control plane to perform a make-before-break operation to verify routing adjustments without interrupting the traffic flows. In some implementations, process 500 includes performing, based on detecting the failure associated with the network device, a make-before-break operation to verify routing adjustments without interrupting the traffic flows.

In some implementations, process 500 includes mapping a bidirectional forwarding detection session to each of the plurality of tunnels to generate a plurality of bidirectional forwarding sessions. In some implementations, process 500 includes monitoring the plurality of bidirectional forwarding sessions. In some implementations, detecting the failure associated with the network device includes detecting a failure in one of the plurality of bidirectional forwarding sessions based on monitoring the plurality of bidirectional forwarding sessions, and detecting the failure associated with the network device based on detecting the failure in the one of the plurality of bidirectional forwarding sessions.

In some implementations, process 500 includes generating a new equal-cost multi-path configuration that includes the plurality of tunnels except the tunnel associated with the network device associated with the failure. In some implementations, process 500 includes achieving network convergence for the plurality of network devices, other than the network device, in less than one second.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
defining, by an edge network device, a plurality of tunnels through a plurality of network devices;
load balancing, by the edge network device, traffic flows among the plurality of tunnels;
detecting, by the edge network device, a failure associated with a network device of the plurality of network devices;
identifying, by the edge network device, a tunnel, of the plurality of tunnels, that is associated with the network device; and
removing, by the edge network device, the tunnel from an equal-cost multi-path configuration to prevent the traffic flows over the tunnel.

2. The method of claim 1, further comprising:
redistributing the traffic flows among the plurality of tunnels other than the tunnel.

3. The method of claim 1, further comprising:
notifying a control plane of the edge network device about the failure associated with the network device, to cause the control plane to perform a make-before-break operation to verify routing adjustments without interrupting the traffic flows.

4. The method of claim 1, further comprising:
performing, based on detecting the failure associated with the network device, a make-before-break operation to verify routing adjustments without interrupting the traffic flows.

5. The method of claim 1, further comprising:
mapping a bidirectional forwarding detection session to each of the plurality of tunnels to generate a plurality of bidirectional forwarding sessions.

6. The method of claim 5, further comprising:
monitoring the plurality of bidirectional forwarding sessions.

7. The method of claim 6, wherein detecting the failure associated with the network device comprises:
detecting a failure in one of the plurality of bidirectional forwarding sessions based on monitoring the plurality of bidirectional forwarding sessions; and
detecting the failure associated with the network device based on detecting the failure in the one of the plurality of bidirectional forwarding sessions.

8. An edge network device, comprising:
one or more memories; and
one or more processors to:
define a plurality of tunnels through a plurality of network devices;
load balance traffic flows among the plurality of tunnels;
detect a failure associated with a network device of the plurality of network devices;
identify a tunnel, of the plurality of tunnels, that is associated with the network device;
remove the tunnel from an equal-cost multi-path configuration to prevent the traffic flows over the tunnel; and
redistribute the traffic flows among the plurality of tunnels other than the tunnel.

9. The edge network device of claim 8, wherein the one or more processors, to identify the tunnel, of the plurality of tunnels, that is associated with the network device, are to:
utilize a packet forwarding component of the edge network device to identify the tunnel, of the plurality of tunnels, that is associated with the network device.

10. The edge network device of claim 8, wherein the one or more processors, to remove the tunnel from the equal-cost multi-path configuration, are to:
utilize a packet forwarding component of the edge network device to remove the tunnel from the equal-cost multi-path configuration.

11. The edge network device of claim 8, wherein the one or more processors are further to:
generate a new equal-cost multi-path configuration that includes the plurality of tunnels except the tunnel associated with the network device associated with the failure.

12. The edge network device of claim 8, wherein each of the plurality of tunnels is an Ethernet virtual private network type 5 tunnel.

13. The edge network device of claim 8, wherein the one or more processors are further to:
achieve network convergence for the plurality of network devices, other than the network device, in less than one second.

14. The edge network device of claim 8, wherein the plurality of network devices form an Ethernet virtual private network.

15. A non-transitory computer-readable medium storing a set of instructions, the set of instructions comprising:
one or more instructions that, when executed by one or more processors of an edge network device, cause the edge network device to:
define a plurality of tunnels through a plurality of network devices,
wherein each of the plurality of tunnels is an Ethernet virtual private network type 5 tunnel;
load balance traffic flows among the plurality of tunnels;
detect a failure associated with a network device of the plurality of network devices;
identify a tunnel, of the plurality of tunnels, that is associated with the network device; and
remove the tunnel from an equal-cost multi-path configuration to prevent the traffic flows over the tunnel.

16. The non-transitory computer-readable medium of claim 15, wherein the one or more instructions further cause the edge network device to:
redistribute the traffic flows among the plurality of tunnels other than the tunnel.

17. The non-transitory computer-readable medium of claim 15, wherein the one or more instructions further cause the edge network device to:
notify a control plane of the edge network device about the failure associated with the network device, to cause the control plane to perform a make-before-break operation to verify routing adjustments without interrupting the traffic flows.

18. The non-transitory computer-readable medium of claim 15, wherein the one or more instructions further cause the edge network device to:
map a bidirectional forwarding detection session to each of the plurality of tunnels to generate a plurality of bidirectional forwarding sessions; and
monitor the plurality of bidirectional forwarding sessions.

19. The non-transitory computer-readable medium of claim 18, wherein the one or more instructions, that cause the edge network device to detect the failure associated with the network device, cause the edge network device to:
detect a failure in one of the plurality of bidirectional forwarding sessions based on monitoring the plurality of bidirectional forwarding sessions; and detect the failure associated with the network device based on detecting the failure in the one of the plurality of bidirectional forwarding sessions.

20. The non-transitory computer-readable medium of claim 15, wherein the one or more instructions, that cause the edge network device to remove the tunnel from the equal-cost multi-path configuration, cause the edge network device to:
utilize a packet forwarding component of the edge network device to remove the tunnel from the equal-cost multi-path configuration.
